(19) United States
(12) Patent Application Publication
(10) Pub. No.: US 2017/0280232 A1
(43) Pub. Date: Sep. 28, 2017

(54) USER TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Yuanjia YANG, Beijing (CN)

(21) Appl. No.: 15/242,119

(22) Filed: Aug. 19, 2016

Related U.S. Application Data
(63) Continuation of application No. PCT/CN2016/088662, filed on Jul. 5, 2016.

(30) Foreign Application Priority Data
Mar. 25, 2016 (CN) 2016101769829

(51) Int. Cl. H04R 1/28; H04R 3/00

(52) U.S. Cl. CPC H04R 1/2873; H04R 3/007; H04R 2499/11; H04R 2430/01

(57) ABSTRACT

Disclosed is a user terminal employing a 2-in-1 audio output structure which combines a speaker and a receiver. The said user terminal comprises a receiver sound outlet configured on a first side of the said user terminal, and a receiver leakage aperture configured, on a second side of the said user terminal, as a passage for releasing concentrated energy which cannot be released by the said receiver sound outlet in time, wherein the said second side is different from the said first side.

### CROSS REFERENCE TO RELATED DISCLOSURES

The present application is a continuation of PCT application which has an application number of PCT/CN2016/088662 and was filed on Jul. 5, 2016. The present application claims the priority of a Chinese patent application titled “user terminal”, which was filed with the Chinese Patent Office on Mar. 25, 2016 and has an application number of 201610176982.9, the contents of which are incorporated by reference herein in its entirety.

### TECHNICAL FIELD

The present application relates to a user terminal, a user terminal employing a 2-in-1 audio output structure, which combines a speaker and a receiver, in particular.

### BACKGROUND

In pursuance of being thin in thickness, low in cost, and of desirable appearance for producing good quality sound, user terminals nowadays adopt designs which integrate a speaker into a receiver. Such a speaker acts as a broadcast unit in a free-hand mode and acts as a broadcast unit in a hand-held mode. A Chinese utility model, whose publication number is CN202261181U, discloses a terminal employing a 2-in-1 speaker and it also discloses a design of driver for a 2-in-1 speaker, wherein a software controls to reduce a gain parameter of a gain-adjustable audio amplifier when a user chooses to output audio from the receiver; the software controls to increase the gain parameter of the gain-adjustable audio amplifier when the user chooses to output audio from the speaker.

FIG. 1 schematically illustrates a user terminal 10 using a 2-in-1 speaker structure 20. The 2-in-1 speaker structure 20 comprises a diaphragm structure 21 and a speaker housing 22. Sound from the diaphragm structure 21 is directed out through a sound outlet 23 configured on a housing of the user terminal 10, as shown by divergent upward arrows 301 in FIG. 1.

Problems of related prior arts, which were identified by the inventors during the process of realizing the present application, are that: a potential risk when implementing a 2-in-1 speaker solution on a user terminal is that because the receiver under the hand-held calling mode and the speaker under the hand-free broadcasting mode share the very same sound outlet, the hardware design determines a too high volume under the hand-held mode. Once a hearing protection mode from the software fails to function properly, excessive energy from the diaphragm structure will concentrate at the sound outlet at the moment when a large signal is broadcast. It would thereby cause damage to the user's hearing capability and, in some serious cases, irreversible permanent damage or even complete loss of hearing. In events of misusing a 2-in-1 speaker by the user, they might suffer serious consequences which could not be possibly imagined.

### SUMMARY

Therefore, the present invention aims to solve one or more of the mentioned problems, and is to provide an ultimate solution for user terminals, which employ a 2-in-1 speaker, as well as to completely avoid causing the mentioned damage.

According to an aspect of the present disclosure, there is provided a user terminal employing a 2-in-1 audio output structure which combines a speaker and a receiver. The user terminal comprises a receiver sound outlet configured on a first side of the user terminal, and a receiver leakage aperture configured, on a second side of the said user terminal, as a passage for releasing concentrated energy that cannot be released by the said receiver sound outlet in time, wherein the said second side is different from the said first side.

In an embodiment, the said second side is a side adjacent to the first side.

In an embodiment, the said second side is a side opposite to the first side.

Furthermore, the user terminal further comprises a speaker sound outlet configured on a third side of the user terminal, wherein the said third side is different from the first side.

In an embodiment, the said second side and the said third side are the same or different sides of the said user terminal.

In an embodiment, the said receiver sound outlet and the said receiver leakage aperture are configured to be the front chamber which is connected to the said 2-in-1 audio output structure which combines a speaker and a receiver, and the said speaker sound outlet is configured to be the rear chamber which is connected to the said 2-in-1 audio output structure which combines a speaker and a receiver. In another embodiment, the said receiver sound outlet and the said receiver leakage aperture are configured to be the rear chamber which is connected to the said 2-in-1 audio output structure which combines a speaker and a receiver, and the said speaker sound outlet is configured to be the front chamber which is connected to the said 2-in-1 audio output structure which combines a speaker and a receiver.

To properly direct and release the concentrated energy towards other directions, existing ways of designing a peripheral structure of a user terminal which employs a 2-in-1 speaker, are to be changed, by way of adding more leakage apertures, in accordance with the implementing methods of the present invention. As such, even if that the user misuses a mobile phone and that software protection fails to operate properly occurred simultaneously, no injury would cause to anyone.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a schematic view of a user terminal employing a 2-in-1 speaker structure in the prior art;

FIG. 2 illustrates a schematic view of a user terminal employing a 2-in-1 speaker structure according to an embodiment of the present invention; and

FIG. 3 illustrates a schematic view of a user terminal employing a 2-in-1 speaker structure according to another embodiment of the present invention.

### DETAILED DESCRIPTION

Exemplary embodiments of the present disclosure will be described in more detail below with reference to figures. Although figures provided illustrate exemplary embodiments of the present application, it should be appreciated that the present disclosure may be implemented through various forms and should not be limited by embodiments herein. On the contrary, these embodiments provide for complete understanding of the present disclosure, and are sought to fully convey the scope of this disclosure to those skilled in the art.

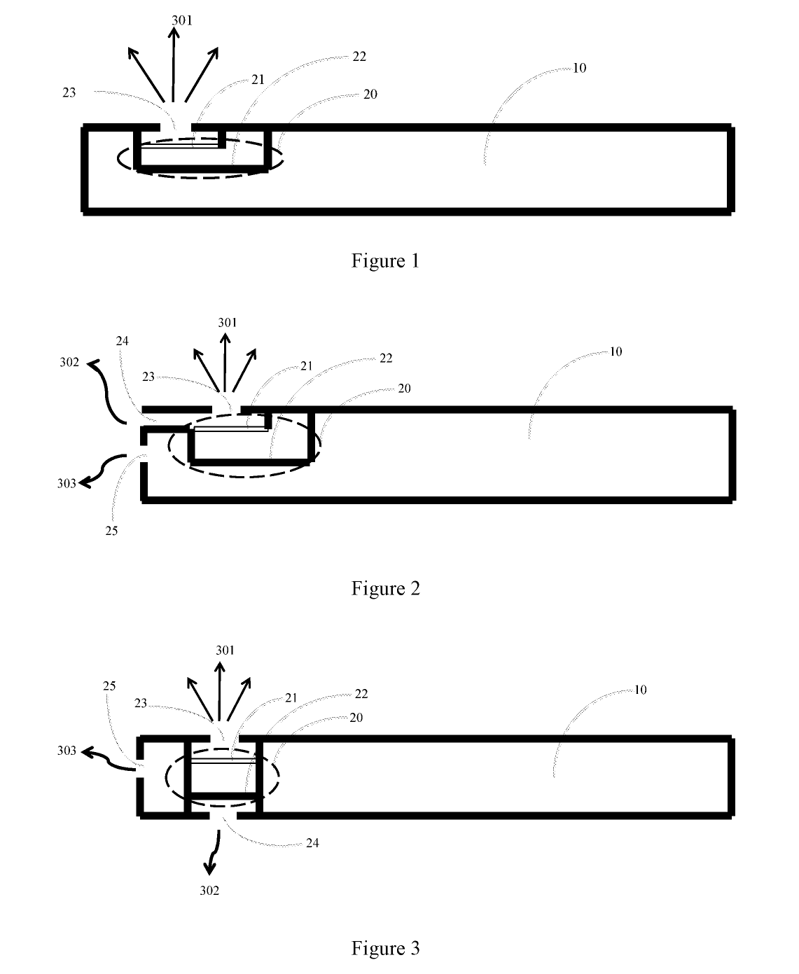

FIG. 2 illustrates a schematic view of a user terminal 10 employing a 2-in-1 speaker structure 20 according to an embodiment of the present disclosure. As shown in FIG. 2, the 2-in-1 speaker structure 20 comprises a diaphragm structure 21 and a speaker housing 22, the user terminal 10 comprises a sound outlet 23 configured on the housing, which is the same as shown in FIG. 1. However, different from the user terminal shown in FIG. 1, the user terminal 10 shown in FIG. 2 further comprises a receiver leakage aperture 24 and a speaker sound outlet 25 configured on the housing of the user terminal 10.

In the embodiment shown in FIG. 2, the sound from the diaphragm structure 21 may be directed out through the receiver sound outlet 23 which is configured on the housing of the user terminal 10, as shown by the divergent upward arrows 301 in the figure. The sound from the diaphragm structure 21 may also be directed out through the speaker sound outlet 25 configured on the housing of the user terminal 10, as shown by the leftward and downward arrow 303 in the figure. Those skilled in the art will appreciate that parameters in the interior of the speaker structure 20 may be adjusted so as to enable sound to egress through either the receiver sound outlet 23 or the speaker sound outlet 25. Embodiment of the present invention focus on the peripheral hardware design of the 2-in-1 speaker structure of the user terminal, and will not emphasize any procedures of adjusting parameters in the interior of the speaker structure 20.

As shown in FIG. 2, the receiver leakage aperture 24 is added laterally on the left side of the receiver sound outlet 23 of the user terminal 10 and configured to be a release passage for concentrated energy which cannot be released by the receiver sound outlet 23 in time, as shown by the arrow 302 in FIG. 2. The reason why a 2-in-1 speaker might cause damage to hearing is: when the user terminal (e.g. a mobile phone) is in the hand-held calling mode, the speaker of the user terminal is so close to the user's ear; if the user misuses or the software hearing protection mode fails, since the sealing performance between the user terminal and the user's auricle is excellent, energy generated by the device diaphragm propelling air is output out of the ear canal in a concentrated manner, thereby causing injury to the hearing organ. According to an embodiment of the present invention, addition of the leakage aperture 24 can release the concentrated energy from the left side of the user terminal 10, and ensures no impact to the user's ear canal. Meanwhile, assume that the side where the receiver sound outlet 23 lies is a main surface of the user terminal 10, the direction of the leakage aperture 24 makes the direction of leakage not towards another person other than the user who makes a call when holding the mobile terminal. It thereby ensures proper release of energy; users' call privacy is also ensured.

As an embodiment of the present disclosure, as shown in FIG. 2, the receiver sound outlet 23 is configured on an upper side of the user terminal 10, and the speaker sound outlet 25 is added on the left side of the hosing of the user terminal 10. As such, this, together with adjustment of a smart processing amplifier and algorithm in the speaker structure 20, can boost users' stereo sound experience. Such solution, in which the receiver sound outlet 23 and the speaker sound outlet 25 is further separated, avoids, from a perspective of hardware design, risks resulting from the fact that the speaker of the user terminal for the free-hand broadcast mode and receiver for the hand-held calling broadcast mode share one single sound outlet.

For ease of depiction, a space between the diaphragm structure 21 and the sound outlet 23 can be defined as a sound output front chamber of the speaker structure 20; a space between the diaphragm structure 21 and the speaker housing 22 forms a sound output rear chamber of the speaker structure 20. Those skilled in the art appreciate that the speaker housing 22 of the 2-in-1 speaker structure 20 comprises a single leakage aperture to ensure balance of air pressure that the diaphragm structure 21 receives in an up-down direction (FIG. 2). Hence, in an example shown in FIG. 2, the receiver sound outlet 23 is configured to use sound or acoustic wave coming from the front chamber of the 2-in-1 speaker structure 20, and the speaker sound outlet 25 is configured to use sound or acoustic wave coming from the rear chamber of the 2-in-1 speaker structure 20.

However, it should be appreciated that the embodiment as shown in FIG. 2 in which the receiver sound outlet 23 is separate from the speaker sound outlet 25 (on different sides) is only exemplary and not restrictive, and is only a preferred design scheme of embodiments of the present disclosure. The present disclosure may further employ a design scheme as shown in FIG. 1 in which the speaker sound outlet and the receiver sound outlet use the same sound outlet. With the receiver leakage aperture 24 being added to release the excessive energy concentrated at the sound outlet 23, impact from sound leakage that might be caused when the sound outlet 23 serves as the hand-free mode speaker may be avoided by means of design of a leakage path being connected to the leakage aperture 24 and/or in conjunction with a software algorithm.

FIG. 3 illustrates a schematic view of a user terminal 10 employing a 2-in-1 speaker structure 20 according to another embodiment of the present disclosure, which serves as an improved design of the hardware structure design of the user terminal shown in FIG. 2. As shown in FIG. 3, the 2-in-1 speaker structure 20 comprises a diaphragm structure 21 and a speaker housing 22, the user terminal 10 comprises a sound outlet 23 configured on the housing, wherein sound from the diaphragm structure 21 is directed out through the sound outlet 23. The user terminal 10 further comprises a first hole 24 and a second hole 25 on the housing of the user terminal. In an embodiment, the first hole 24 may be configured as receiver leakage aperture, and the second hole 25 may be configured as the speaker sound outlet. In another embodiment, the first hole 24 may be configured as the speaker sound outlet, and the second hole 25 may be configured as the receiver leakage aperture.

According to an embodiment of the present disclosure, the receiver leakage aperture is configured to form a release passage for concentrated energy that cannot be released by the receiver sound outlet in time.

In a further embodiment, design of the leakage passage which is connected to the leakage aperture may take into account assurance of protection for the user's ear when the software fails, as well as improvement of users' experience of making hand-held calls. The design of the leakage passage may take into consideration the following principles:

(1) When energy leaks out from the acoustic front chamber, length and cross-sectional area of the front chamber leakage aperture need to satisfy certain requirements of proportionality, so that the resonant frequency of a high-frequency bandwidth portion does not attenuate abruptly, and that size parameters may be debugged very quickly through a lumped parameter method circuit simulation model.

(2) When energy leaks out from the rear chamber, the leakage aperture should be big enough to ensure that voice and music volume upon hand-free broadcasting reaches a certified standard value. Usually, 5-8mm2 may suffice a universal micro-speaker.

Examples of user terminal as described in embodiments of the present disclosure include but not limited to a cellular phone, a smart phone, a media player, a portable computer similar to a tablet, and any user equipment provided with a speaker. All of these may have an embedded 2-in-1 speaker system which supports broadcasting by speaker under hand-free mode and broadcasting by receiver under hand-held mode.

Embodiments of the present disclosure set to improve speaker peripheral structural design of user terminal upon performing hardware structure design for user terminals which employ a 2-in-1 speaker. The aforesaid 2-in-1 speaker structure 20 may employ any audio output products available in market which combine a speaker and a receiver. Those skilled in the art appreciate that the 2-in-1 speaker structure 20 may further comprise members such as a voice coil, a spider, an edge, an anti-dust cover, a magnet, a magnetic conducting column and a magnetic conducting plate.

According to embodiments of the present disclosure, it is feasible to ensure multimedia sound effect of a user terminal and effectively eliminate risks causing damage to hearing, without increasing costs, or even reducing costs.

It should be appreciated that although the description may include terms such as “first” and “second” to describe various elements, the elements should not be limited by these terms because these are only used to distinguish one element from another. For example, the first element may be called the second element, and similarly the second element may also be called the first element without departing from the scope of exemplary embodiments. Similarly, the terms “front” and “rear”, “left” and “right”, “up” and “down” used in the description are only relative concepts and should be interpreted in a similar way.

The description of the present disclosure has already been presented for purpose of illustration and depiction, but it is not intended to exhaust or be limited to the embodiments disclosed. Those skilled in the art may think of many modifications and variations. Such Modifications and substitutions made without departing from the spirit of the present invention will still fall within the scope, which is defined by the appended claims, of protection of the present invention.

1. A user terminal employing a 2-in-1 audio output structure which combines a speaker and a receiver, wherein the said user terminal comprises:
a receiver sound outlet configured on a first side of the said user terminal; and
a receiver leakage aperture configured, on a second side of the said user terminal, as a passage for releasing concentrated energy which cannot be released by the said receiver sound outlet in time, wherein the said second side is different from the said first side.

2. The user terminal according to claim 1, wherein
the said second side is a side adjacent to the first side.

3. The user terminal according to claim 1, wherein
the said second side is a side opposite to the first side.

4. The user terminal according to claim 1, wherein the said user terminal further comprises:
a speaker sound outlet configured on a third side of the said user terminal, wherein the said third side is different from the said first side.

5. The user terminal according to claim 4, wherein
the said second side and the said third side are identical or different sides of the said user terminal.

6. The user terminal according to claim 4, wherein
the said receiver sound outlet and the said receiver leakage aperture are configured to be the front chamber which is connected to the said 2-in-1 audio output structure which combines a speaker and a receiver, and the said speaker sound outlet is configured to be the rear chamber which is connected to the said 2-in-1 audio output structure which combines a speaker and a receiver; or
the said receiver sound outlet and the said receiver leakage aperture are configured to be the rear chamber which is connected to the said 2-in-1 audio output structure which combines a speaker and a receiver, and the said speaker sound outlet is configured to be the front chamber which is connected to the said 2-in-1 audio output structure which combines a speaker and a receiver.
